(19) United States
(12) Patent Application Publication
(10) Pub. No.: US 2026/0138016 A1
(43) Pub. Date: May 21, 2026

(54) INTERACTION CONTROLLING METHOD AND APPARATUS FOR GAME, AND ELECTRONIC DEVICE

(71) Applicant: NETEASE (HANGZHOU) NETWORK CO., LTD., Hangzhou, Zhejiang (CN)

(72) Inventor: Yangchen JIANG, Hangzhou, Zhejiang (CN)

(73) Assignee: NETEASE (HANGZHOU) NETWORK CO., LTD., Hangzhou, Zhejiang (CN)

(21) Appl. No.: 19/121,872

(22) PCT Filed: Mar. 17, 2023
(86) PCT No.: PCT/CN2023/082205

§ 371 Date: Apr. 17, 2025

(30) Foreign Application Priority Data
Oct. 17, 2022 (CN) 202211265116.9

(51) Int. Cl. A63F 13/533; A63F 13/2145

(52) U.S. Cl. CPC A63F 13/533; A63F 13/2145

(57) ABSTRACT

An interaction controlling method and apparatus for a game, and an electronic device. The interaction controlling method includes: in response to a control combination triggering event, displaying in a first display format a plurality of combinable controls among a plurality of operation controls; in response to a control combination operation, displaying a composite control of a plurality of target combinable controls corresponding to the control combination operation; and in response to a touch-control operation acting on the composite control, controlling a controlled virtual object to continuously execute game functions of the plurality of target combinable controls corresponding to the composite control.

### CROSS-REFERENCE TO RELATED APPLICATIONS

The present disclosure is a U.S. National Stage of International Application No. PCT/CN2023/082205, filed on Mar. 17, 2023, which claims priority to Chinese patent application No. 202211265116.9, filed on Oct. 17, 2022, both of which are incorporated by reference herein in their entireties for all purposes.

### TECHNICAL FIELD

The present disclosure relates to the field of game technology, and in particular to interactive control method and apparatus for games and an electronic device.

### BACKGROUND

In the related art, in online games using firearms as combat weapons, players usually need to trigger multiple controls to achieve control of the gun, such as triggering the control corresponding to the aiming lens to open the aiming lens, triggering the control corresponding to reloading to put bullets into the gun, etc. This method makes the control process of the gun more complicated, affecting the game experience of the players.

### SUMMARY

According to a first aspect of the present disclosure, there is provided an interactive control method for a game. A graphical user interface is provided through a terminal device. The graphical user interface displays a scene screen of a game scene where a controlled virtual object is located and a game operation area. The game operation area displays multiple operation controls. The operation controls are configured to control the controlled virtual object to perform corresponding game functions. The method includes displaying multiple combinable controls among multiple operation controls in a first display format in response to a trigger event of control combination; displaying a composite control of multiple target combinable controls corresponding to a control combination operation in response to the control combination operation; and controlling the controlled virtual object to continuously perform game functions of the multiple target combinable controls corresponding to the composite control in response to a touch operation on the composite control.

According to a second aspect of the present disclosure, there is provided an electronic device, including a processor and a memory, where the memory stores machine executable instructions that can be executed by the processor, and the processor executes the machine executable instructions to implement the above interactive control method for the game.

According to a third aspect of the present disclosure, there is provided a non-transitory machine-readable storage medium, where the non-transitory machine-readable storage medium stores machine-executable instructions, and when the machine-executable instructions are called and executed by a processor, the machine-executable instructions cause the processor to implement the above interactive control method for the game.

Other features and advantages of the present disclosure will be explained in the subsequent description, and part of them will become obvious from the description, or be understood by implementing the present disclosure. The purpose and other advantages of the present disclosure are realized and obtained by the structures specifically pointed out in the description, claims and drawings.

In order to make the above-mentioned purposes, features and advantages of the present disclosure more obvious and easy to understand, the following are example embodiments, and in conjunction with the attached drawings, a detailed description is given as follows.

### BRIEF DESCRIPTION OF THE DRAWINGS

In order to more clearly illustrate the specific implementation of the present disclosure or the technical solution in the prior art, the following will briefly introduce the drawings required for use in the description for the embodiments or prior art. Obviously, the drawings in the following description are some embodiments of the present disclosure. For those skilled in the art, other drawings can also be obtained based on these drawings without creative work.

FIG. 1 is a flow chart of an interactive control method of a game provided by an embodiment of the present disclosure;

FIG. 2 is a schematic diagram of a game operation area of a combination process of a combinable control provided by an embodiment of the present disclosure;

FIG. 3 is a schematic diagram of a game operation area showing a cancel control provided by an embodiment of the present disclosure;

FIG. 4 is a schematic diagram of a game operation area showing an execution parameter identifier provided by an embodiment of the present disclosure;

FIG. 5 is a schematic diagram of a game operation area marked with a sliding track provided by an embodiment of the present disclosure;

FIG. 6 is a schematic diagram of a game operation area showing a combinable control provided by an embodiment of the present disclosure;

FIG. 7 is another schematic diagram of a game operation area showing a cancel control provided by an embodiment of the present disclosure;

FIG. 8 is a schematic diagram of prompt information provided by an embodiment of the present disclosure;

FIG. 9 is a structural schematic diagram of an interactive control device of a game provided by an embodiment of the present disclosure;

FIG. 10 is a structural schematic diagram of an electronic device provided by an embodiment of the present disclosure.

### DETAILED DESCRIPTION

In order to make the purpose, technical solution and advantages of the embodiments of the present disclosure clearer, the technical solution of the present disclosure will be described clearly and completely in conjunction with the accompanying drawings. Obviously, the described embodiments are part of the embodiments of the present disclosure, not all of the embodiments. Based on the embodiments in the present disclosure, all other embodiments obtained by those skilled in the art without creative work are within the scope of protection of the present disclosure.

In combat games, the virtual objects controlled by the players usually have set skills or control set weapons, and fight against the enemy virtual objects by triggering skills or using weapons. For example, in online games using firearms as combat weapons, players usually need to trigger multiple controls to realize the control of the virtual object over the gun, such as triggering the control corresponding to the aiming lens to open the aiming lens (which can be called “aim down sights (ADS)”), triggering the control corresponding to the reloading to put bullets into the gun, etc.

In a certain shooting game, a shooting mode is set: one-button ADS and fire. By selecting the fire mode for a certain firearm in the options in the game settings, the operation of the controls is reduced, making the fire process faster. However, this method is relatively single and cannot meet the various game operation needs of players.

Based on this, one or more embodiments of the present disclosure provide interactive control method and device for games and an electronic device, and the technology can be applied to a combat game scene including multiple game operation controls.

In an embodiment of the present disclosure, the game interactive control method can be run on a local terminal device or a server. When the game interactive control method is run on a server, the method can be implemented and executed based on a cloud interactive system, where the cloud interactive system includes a server and a client device.

In an embodiment, various cloud applications can be run under the cloud interactive system, such as a cloud game. Taking the cloud game as an example, the cloud game refers to a game method based on cloud computing. In the operation mode of the cloud game, the game execution host and the game rendering host are separated. The storage and operation of the interactive control method of the game are completed on the cloud game server, and the client device is used for receiving and sending data and presenting the game screen. For example, the client device can be a display device with data transmission function close to the user side, such as a mobile terminal, a TV, a computer, a handheld computer, etc.; but the cloud game server in the cloud performs information processing. When playing the game, the player operates the client device to send an operation instruction to the cloud game server. The cloud game server runs the game according to the operation instruction, encodes and compresses data such as the game screen and the like, returns it to the client device through the network, and finally the client device decodes and outputs the game screen.

In an embodiment, taking the game as an example, the local terminal device stores the game program and is configured to present the game screen. The local terminal device is configured to interact with the player through a graphical user interface. That is, the game program is conventionally downloaded and installed and run by the electronic device. The local terminal device can provide the graphical user interface to the player in a variety of ways. For example, the graphical user interface can be rendered and displayed on the display screen of the terminal, or provided to the player through holographic projection. For example, the local terminal device may include a display screen and a processor. The display screen is configured to present the graphical user interface. The graphical user interface includes the game screen. The processor is configured to run the game, generate the graphical user interface, and control the display of the graphical user interface on the display screen.

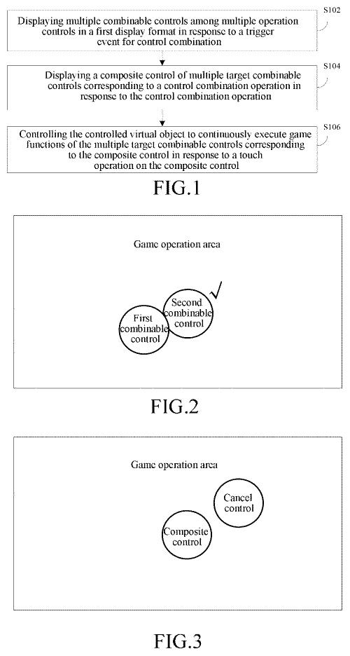

In a possible implementation, the embodiment of the present disclosure provides an interactive control method for a game, providing a graphical user interface through a terminal device. The terminal device can be the local terminal device mentioned above, or it can be a client device in the cloud interaction system mentioned above. The graphical user interface displays the scene screen and the game operation area of the game scene where the controlled virtual object is located. The game operation area displays multiple operation controls. The operation controls are configured to control the controlled virtual object to perform the corresponding game function. As shown in FIG. 1, the method includes the following steps:
Step S102, displaying multiple combinable controls among multiple operation controls in a first display format in response to a trigger event for control combination.

The above-mentioned trigger event for control combination can be generated by the player clicking or long pressing the control pre-set in the graphical user interface for triggering the control combination mode, and can also be generated by the player performing a specified touch operation on a certain operation control in the game operation area. The specified touch operation is usually different from the touch operation that triggers the operation control. In addition, the player can also pre-set the function execution mode of the game through the corresponding control in the game setting page, so that after the player enters the combat mode, the trigger event for control combination is generated, and the player can perform the control combination operation. There are many specific methods, which are not limited here.

The above-mentioned combinable control is usually an operation control of which corresponding game function can be executed continuously with other game functions. For example, in a certain game, in order to obtain a certain prop, the player needs to control the controlled virtual object to jump, and then control the controlled virtual object to grab the prop. At this time, the operation control for controlling the controlled virtual object to jump and the operation control for controlling the controlled virtual object to grab can be used as combinable controls.

In the game, the implementation process of set skills may require the player to operate multiple operation controls in a set order. These operation controls can be used as combinable controls for the player to perform control combination operations. For example, when controlling the controlled virtual character to use a gun prop to shoot, it is usually necessary to put bullets into the gun prop, aim, and then shoot; usually corresponding operation controls are set for the above three operations. These three operation controls can be set as combinable controls.

The above first display format is usually different from the conventional display format of the operation control, and effects such as highlight, vibration or light effects, etc. can be added to the combinable control based on the conventional display format of the operation control. Players can distinguish which operation controls are combinable and which operation controls are not combinable based on the display formats of the operation controls, so as to facilitate the subsequent control combination operation.
Step S104, displaying a composite control of multiple target combinable controls corresponding to a control combination operation in response to the control combination operation.

The above control combination operation can be a player dragging multiple combinable controls to be combined to a certain position in the game operation area. The position can be pre-set with a combinable control, or it can be a previously empty position. If the position is pre-set with a combinable control, it can be considered that the combinable control is the first combined combinable control.

When the player drags the second combinable control to the display position of the first combined combinable control, an indicator mark can be displayed on the graphical user interface to prompt the player that if the combinable control is released at the current position, the second combinable control can be combined with the first combined combinable control to generate a composite control. The above indicator mark can be a halo effect displayed around the first combined combinable control, or a check mark indicating the combination, etc. Similarly, when the composite control has been generated, when the player drags other combinable controls to the position where the composite control is displayed, an indicator mark can also be displayed to prompt the player to release the combinable control to achieve the continued combination of the current combinable control and the composite control.

The above-mentioned composite control can be displayed as a control with a larger size than the ordinary operation control. In order to prompt the player which controls are combined, the name or logo of the combined operation control can also be marked on the composite control.
Step S106, controlling the controlled virtual object to continuously execute game functions of the multiple target combinable controls corresponding to the composite control in response to a touch operation on the composite control.

The above-mentioned touch operation is usually a click operation on the composite control. After the composite control is clicked, the controlled virtual object can be controlled to continuously execute the game functions of the multiple target combinable controls corresponding to the control. The execution order can be the combination order of the target combinable controls, or the reverse order of the combination order, which can be preset.

In the process of the controlled virtual object executing the game functions of the multiple target combinable controls, an indication mark of corresponding game function can be displayed to indicate parameters such as the execution progress of the game function and the execution event of the game function, etc. In addition, a cancel control corresponding to the composite control can be set in the game operation area. In the process of the controlled virtual object executing the game functions of the multiple the target combinable controls, if the player clicks the cancel control, the controlled virtual object can stop executing the game functions of the multiple target combinable controls, or stop executing the game function of the current target combinable control, so as to execute the game function of the next target combinable control.

Since multiple target combinable controls are combined into a composite control, it is difficult for the player to operate each target combinable control individually. Therefore, the composite control can be temporarily displayed as the corresponding multiple target combinable controls by performing a set touch operation on the composite control, such as long pressing the composite control. At this time, the player can select several target combinable controls from the displayed multiple target combinable controls through a sliding operation connected to the long pressing operation, so that the controlled virtual object executes the functions of the selected several target combinable controls, and the execution order can be the same as the order in which the player's sliding operation passes through the target combinable controls.

The above interactive control method of the game includes in response to the trigger event for control combination, displaying multiple combinable controls among multiple operation controls in the first display format; in response to the control combination operation, displaying the composite control of multiple target combinable controls corresponding to the control combination operation; in response to the touch operation on the composite control, controlling the controlled virtual object to continuously execute the game functions of the multiple target combinable controls corresponding to the composite control. This method meets the diverse game operation requirements of players, makes game operation more convenient, and improves the game experience of players.

The following embodiment provides a specific implementation for displaying multiple combinable controls among multiple operation controls in the first display format in response to the trigger event for control combination.

In the specific implementation, after the player performs a touch operation on any one of the multiple operation controls, the multiple combinable controls in the multiple operation controls can be displayed in the first display format in response to the touch operation on the operation control in the multiple operation controls. The above-mentioned touch operation should be distinguished from the conventional operation on the operation control. For example, if the conventional operation on the operation control is a click operation, the triggering operation for triggering the control combination event can be a long press operation. A certain operation control can also be designated as an operation control that can trigger the display of a combinable control. When the player performs a touch operation on the designated operation control, multiple combinable controls in multiple operation controls are displayed in a first display format.

Among multiple operation controls, some operation controls can only be combined with one or more set operation controls. When the player performs a touch operation on a certain operation control, the operation control is called a first operation control, and in response to the touch operation on the first operation control in multiple operation controls, at least one combinable control corresponding to the first operation control in multiple operation controls can be displayed in a first display format. The above-mentioned first display format can be a highlight display, a display jitter effect, etc., so that the display format of the combinable control is different from other operation controls that cannot be combined.

In addition, a control for triggering a control combination mode can be set in advance in the graphical user interface. In order to prevent players from accidentally touching it during the game operation, the control for triggering the control combination mode is usually set at a position far away from the game operation area. For example, the game operation area is usually set in the lower right corner area of the graphical user interface, and the control for triggering the control combination mode can be set in the upper left corner area or the lower left corner area of the graphical user interface. Players can generate a trigger event for control combination by clicking or long pressing the control.

The following embodiment provides a specific implementation for displaying a composite control of multiple target combinable controls corresponding to the control combination operation in response to the control combination operation.

The target combinable controls include at least two combinable controls, one of which can be called a first combinable control. The player can first select the first combinable control among the multiple combinable controls. Assuming that not all combinable controls can be combined with each other, in response to a first selection operation on the first combinable control among the multiple combinable controls, at least one combinable control corresponding to the first combinable control among the multiple combinable controls is displayed in a second display format. The second display format can be a highlight, vibration or halo format to prompt the player that these combinable controls can be combined with the first combinable control. Then the player can select the first combinable control and at least one second combinable control among the corresponding combinable controls, and in response to a second selection operation, a composite control corresponding to the first combinable control and at least one second combinable control is displayed, where the second selection operation is configured to select the first combinable control and the at least one second combinable control among the at least one combinable control corresponding to the first combinable control as the selected controls.

There may be multiple kinds of second selection operation. For example, the second selection operation is a sliding operation, and the track of the sliding operation passes through the first combinable control and the at least one second combinable control, and can be started at the first combinable control and ended at the second combinable control; or can be started at the second combinable control and ended at the first combinable control. The above second selection operation is also composed of multiple sub-click operations, where the multiple sub-click operations correspond to the first combinable control and the at least one second combinable control. That is, the player can click the first combinable control and at least one second combinable control in sequence to generate a corresponding composite control.

Taking the control combination of the first combinable control and a second combinable control as an example, the combination process is specifically described. The player can drag the first combinable control to the display position of the second combinable control to generate a composite control corresponding to the two. Specifically, in response to a sliding operation starting from the position of the first combinable control and ending at the position of a second combinable control in at least one combinable control corresponding to the first combinable control, the composite control corresponding to the first combinable control and the second combinable control is displayed.

In the specific implementation, in response to the sliding operation starting from the position of the first combinable control, the first combinable control is controlled to move along with the contact point of the sliding operation, and the operation can be regarded as a drag operation on the first combinable control. In response to the contact point of the sliding operation moving to the display position of a second combinable control in at least one combinable control corresponding to the first combinable control, a control combination mark is displayed. The control combination mark is configured to indicate that the first combinable control is combined with the second combinable control, and the combination mark can be a check mark, as shown in FIG. 2. In response to an end event of the sliding operation at the position of the second combinable control, the composite control corresponding to the first combinable control and the second combinable control is displayed at the position of the second combinable control.

When it is necessary to combine another second combinable control in the combinable controls corresponding to the first combinable control with the generated composite control, a sliding operation can also be performed starting from the display position of another second combinable control. In response to the sliding operation starting from the display position of another second combinable control in the at least one combinable control corresponding to the first combinable control and ending at the display position of the composite control, the composite control is updated and displayed; where the updated composite control corresponds to the first combinable control and the two second combinable controls.

In addition, the combination of controls can be canceled by a touch operation on the composite control. Specifically, the player can long-press the composite control for a preset time period. In response to the long-press operation on the composite control, a cancel control corresponding to the composite control is displayed at a specified position of the composite control, as shown in FIG. 3. In response to a sliding operation starting from the composite control and ending at the cancel control, the display of the composite control is canceled. That is, the player drags the composite control to the display position of the cancel control, and the combination of controls is canceled.

In the specific implementation process, it can also be set that after the player clicks the cancel control, the display of the composite control is canceled in response to a click operation on the cancel control.

The following embodiment provides a specific implementation for controlling a controlled virtual object to continuously execute the game functions of multiple target combinable controls corresponding to the composite control in response to a touch operation on the composite control.

Since the composite control is mainly used for the continuous execution of game functions, a click operation can be set as the most common triggering method of the control. After the player clicks the composite control, in response to the click operation on the composite control, the controlled virtual object can be controlled to sequentially execute the game functions corresponding to the multiple combinable controls in the combination order of the multiple combinable controls corresponding to the composite control; the combination order of the multiple target combinable controls corresponding to the composite control is determined based on the control combination operation corresponding to the composite control. For example, the player drags the first target combinable control and the second target combinable control to the display position of the third combinable control in turn to generate the corresponding composite control, and the combination order is the third target combinable control, the first target combinable control, and the second target combinable control.

In the specific implementation process, other touch operations can also be set as the triggering mode of the composite control to realize the continuous execution mode of various game functions. For example, the player can double-click the composite control, and in response to the double-click operation on the composite control, the multiple target combinable controls corresponding to the composite control are displayed at the specified position of the graphical user interface. At this time, the target combinable controls can be arranged in their combination order, as shown in FIG. 4, assuming that their combination order is the first control, the second control and the third control. The controlled virtual object is controlled to sequentially execute the game functions corresponding to the multiple combinable controls in the combination order of the multiple combinable controls corresponding to the composite control, according to the above, i.e., the game functions corresponding to the first control, the second control and the third control respectively. The combination order of the multiple target combinable controls corresponding to the composite control is determined based on the control combination operation corresponding to the composite control. In the process that the controlled virtual object sequentially executes the game functions corresponding to the multiple combinable controls according to the combination order of the multiple combinable controls corresponding to the composite control, the player can perform a touch operation on a certain control in the displayed target combinable controls, and in response to the touch operation on the first target combinable control in the multiple combinable controls corresponding to the composite control, the execution state of the currently executed game function of the controlled virtual object is controlled to change.

As shown in FIG. 4, while displaying the multiple target combinable controls corresponding to the composite control at the specified position of the composite control, the execution parameter mark of the game function corresponding to the target combinable control can also be displayed at the specified position of the target combinable control. The execution parameter mark is configured to indicate the execution time and or the execution progress of the game function. The progress bar in FIG. 4 shows that the execution progress of the first control is 50% and the execution time is 1 s; the execution progress of the second control is 0% and the execution time is 3 s; the execution progress of the third control is 0% and the execution time is 2 s.

When controlling the execution state of the game function of the controlled virtual object, in response to a double-click operation on the first target combinable control among the multiple target combinable controls corresponding to the composite control, the game function corresponding to the first target combinable control can be canceled in the execution state of the game function. For example, if the game function corresponding to the first control is being executed, and the third control is double-clicked, it is end directly after the controlled virtual object executes the sub-state corresponding to the second control.

In addition, the player can also perform a click operation on the displayed target combinable control. In response to the click operation on the first target combinable control among the multiple target combinable controls corresponding to the composite control, the controlled virtual object is controlled to execute the game function corresponding to the first target combinable control. This process can be regarded as directly switching the current game function to the game function corresponding to the target combinable control clicked by the player.

In the process of the controlled virtual object executing the game function corresponding to the second target combinable control among the multiple combinable controls, in response to the click operation on the first target combinable control among the multiple target combinable controls corresponding to the composite control, the controlled virtual object is controlled to stop executing the game function corresponding to the second target combinable control; the controlled virtual object is controlled to execute the game function corresponding to the first target combinable control, and the game function corresponding to the combinable control located after the first target combinable control in the combination order of the multiple combinable controls corresponding to the composite control is continued to be executed. For example, in the case shown in FIG. 4, in the process of the controlled virtual object executing the game function of the first control, if the player clicks the second control, the controlled virtual object stops executing the game function of the first control, directly starts executing the game function of the second control, and continues to execute the game function of the third control.

The above-mentioned game operation area can also display a cancel control corresponding to the composite control. After the controlled virtual object is controlled to enter the execution state of the game function, the player can click the cancel control, and in response to the click operation on the cancel control, the controlled virtual object is controlled to stop executing the game function corresponding to the current combinable control, and execute the game function corresponding to the combinable control located after the current combinable control in the combination order.

Since multiple target combinable controls have been combined into a composite control, it is difficult for players to operate each target combinable control individually. Therefore, the composite control can be temporarily restored to separate controls through a set operation to facilitate player operation. Players can long press the composite control for a first preset time. This operation is called the first long press operation. In response to the first long press operation on the composite control, multiple target combinable controls corresponding to the composite control are displayed at multiple set positions starting from the display position of the composite control. This display method can be similar to the display method of the decoding icon of a mobile phone. Each target combinable control corresponds to a decoding number. As shown in FIG. 5, it is composed of the first control, the second control, the third control and the fourth control in the order of writing.

The player can perform a sliding operation starting from the target combinable control displayed at the display position of the composite control. In response to the sliding operation, the target combinable control corresponding to the composite control through which the track of the sliding operation passes is determined as the target trigger control. The first control in FIG. 5 is the target combinable control displayed at the composite control. The track in FIG. 5 passes through the first control, the second control and the fourth control, and these controls are the target trigger controls. In response to the end event of the sliding operation at the display position of the second target combinable control among the multiple target combinable controls corresponding to the composite control, the controlled virtual object is controlled to execute the game functions corresponding to the target trigger controls in the order in which the sliding operation passes through the target trigger controls. The player can also slide to the location of the cancel control to cancel the operation.

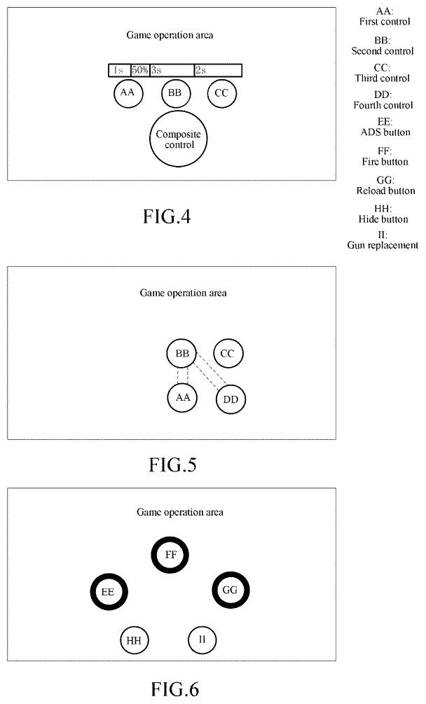

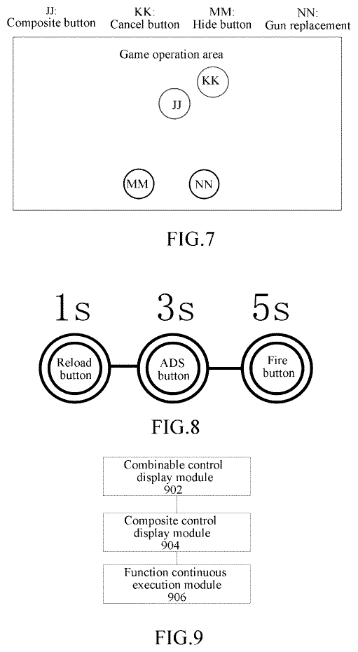

The embodiment of the present disclosure also provides another interactive control method for a game. The method is implemented on the basis of the method shown in FIG. 1. The method is applied to a gunfight game. The operation control (also called a “button”) in the method is configured to control the gun to realize functions such as ADS, firing, and reloading. The generated composite control can be called a “composite button” or a “combined button”. The graphical user interface in the method displays the main interface of the gunfight (also called “combat HUD”), that is, the combat interface of the guns and characters controlled by the player. The method is mainly implemented in the following ways:
1. In the combat HUD, long press the ADS button for 2 seconds to trigger the response of the combinable button. After the response, the border of the button that supports the combined operation can be displayed in a highlighted format. As shown in FIG. 6, the fire button, ADS button and reload button are combinable buttons. The bold edge indicates that the button is displayed in a highlighted format. The gun replacement button and the hide button are non-combinable buttons.
2. Click the combinable button, and the combinable skill button related to the button will be displayed in a highlighted or button shaking form. Drag the clicked button and move it to the top of the combinable button. At this time, V will appear near the composite button for combining the dragged button and the combinable button, indicating that the current combination is successful. After releasing the hand, the button combination takes effect.
3. After the composite button is generated, trigger the composite button. The functions of the multiple buttons corresponding to the composite button will be performed in sequence according to the order of combination. Usually, the button that is combined first will be triggered first. For example, the fire button is used as a combination button. The player drags the controls such as ADS and jump to the fire button in sequence. After the combination is successful, click the combined button. The fire button is the first to respond, followed by the ADS and jump buttons. The function of this combination can be realized by clicking once, and multiple functions are triggered in sequence at the same time. For example, drag the ADS button to the shoot button, and after the V button appears, release the hand to take effect. At this time, clicking the shoot button will trigger the ADS button first, and then shoot.
4. After pressing the composite button for 2 seconds, a close button appears near the composite button, as shown in FIG. 7. Drag the composite button to the close button and release it to cancel the button combination corresponding to the composite button, and cancel the display of the composite button. At the same time, it supports players to click the close button to cancel the combination, and the functional attributes of the corresponding button combination are also cancelled. The buttons of the original combination are reset to the positions before the combination.

Since players need to make timely adjustments according to the current battle situation when controlling guns to fight in the game scene, multiple trigger methods can be set for the composite button. The following is a detailed introduction to various trigger methods:
1. Trigger method by quick release: Click the composite control to quickly activate the control with one click; the activation order is the combination order.
2. Trigger method by controlling release time: Double-click the composite control, and the activation order and activation progress of each control corresponding to the composite control will be displayed above the control, which is convenient for players to monitor and cancel the activation at any time.

Double-clicking the composite control will execute the activation operation of the combined control. The activation order is in the order of the original combination. At the same time, an information prompt is displayed below the gun crosshairs, as shown in FIG. 8, to show the current activation order and progress. In the information prompt, the time above indicates how long it will take to activate the skill. In FIG. 8, the reloading time is 1 second, the ADS time is 3 seconds, and the fire event is 5 seconds. Clicking the skill control in the progress bar will give priority to response and activate. For example, the current reloading skill is still in the process of activation (not completed), and if the ADS progress is clicked at this time, and the reloading operation stops. Give priority to responding to the ADS operation. If there is no other operation, it will be activated from the ADS button to the next step. For example, after activating the ADS, activate the jump, etc.

In addition, you can also click the red cancel button, or double-click any function button in the progress bar shown in FIG. 8 to cancel the current activation behavior. For example, the first reloading operation is currently being executed. At this time, double-click the ADS button to cancel the display of the ADS button, as shown in FIG. 8, and the ADS operation is performed after the reloading is completed.
3. Trigger method by controlling the activation of the skill combination of any button: After long pressing the composite control for 1.5 seconds, the composite control will expand. If you do not let go, start from the default control you hold down and slide directly to the corresponding control and let go. Any combination can be activated. This operation is similar to unlocking a mobile phone by sliding a password.

If you slide to the cancel control and let go, the activation operation behavior of the current combination is canceled.

In this method, players control the activation of the combination of operation buttons and the activation of the combination of control skills with higher degrees of freedom according to their own needs or the needs of the game play. This method expands the freedom of operation through interactive gestures and rule judgments, and also provides more design references for subsequent game play.

For the above method embodiment, referring to an interactive control device for a game shown in FIG. 9, a graphical user interface is provided through a terminal device. The graphical user interface displays the scene screen of the game scene where the controlled virtual object is located and the game operation area. The game operation area displays multiple operation controls. The operation controls are configured to control the controlled virtual object to perform the corresponding game function. The device includes:
a combinable control display module 902, configured to display multiple combinable controls among multiple operation controls in a first display format in response to a trigger event for control combination;
a composite control display module 904, configured to display a composite control of multiple target combinable controls corresponding to a control combination operation in response to the control combination operation;
a function continuous execution module 906, configured to control the controlled virtual object to continuously execute game functions of the multiple target combinable controls corresponding to the composite control in response to a touch operation on the composite control

In the above interactive control device for a game, in response to the trigger event for control combination, display multiple combinable controls among multiple operation controls in a first display format; in response to the control combination operation, display the composite control of multiple target combinable controls corresponding to the control combination operation; in response to the touch operation acting on the composite control, control the controlled virtual object to continuously execute the game functions of multiple target combinable controls corresponding to the composite control. This method meets the diverse game operation requirements of players, makes game operation more convenient, and improves the game experience of players.

The above combinable control display module is further configured to display multiple combinable controls in the multiple operation controls in the first display format in response to a touch operation on an operation control in the multiple operation controls The above combinable control display module is further configured to display at least one combinable control corresponding to a first operation control in the multiple operation controls in the first display format in response to a touch operation on the first operation control in the multiple operation controls.

The above composite control display module is further configured to display at least one combinable control corresponding to the first combinable control in the multiple combinable controls in a second display format in response to a first selection operation of the first combinable control in the multiple combinable controls; and display a composite control corresponding to the first combinable control and at least one second combinable control in response to a second selection operation, wherein the second selection operation is configured to select the first combinable control and the at least one second combinable control among the at least one combinable control corresponding to the first combinable control as the selected controls.

The second selection operation is a sliding operation, where the track of the sliding operation passes through the first combinable control and the at least one second combinable control; or the second selection operation is composed of multiple sub-click operations, where the multiple sub-click operations correspond to the first combinable control and the at least one second combinable control.

The above composite control display module is further configured to display the composite control corresponding to the first combinable control and a second combinable control in response to a first sliding operation starting from the position of the first combinable control and ending at the second combinable control in at least one combinable control corresponding to the first combinable control.

The device further includes a composite control update module, configured to update the display of the composite control in response to a sliding operation starting from the display position of another second combinable control in at least one combinable control corresponding to the first combinable control and ending at the display position of the composite control. The updated composite control corresponds to the first combinable control and two second combinable controls.

The composite control display module is further configured to control the first combinable control to move along with the contact point of the sliding operation in response to a sliding operation starting from the position of the first combinable control; display the control combination mark in response to the contact point of the sliding operation moving to the display position of a second combinable control in at least one combinable control corresponding to the first combinable control, where the control combination mark is configured to indicate that the first combinable control is combined with the second combinable control; and display the composite control corresponding to the first combinable control and the second combinable control at the position of the second combinable control in response to the end event of the sliding operation at the position of the second combinable control.

The above function continuous execution module is further configured to control the controlled virtual object to sequentially execute the game functions corresponding to the multiple combinable controls in the combination order of the multiple combinable controls corresponding to the composite control in response to a click operation on the composite control; the combination order of the multiple target combinable controls corresponding to the composite control is determined based on the control combination operation corresponding to the composite control.

The above function continuous execution module is further configured to display multiple target combinable controls corresponding to the composite control at a specified position of the graphical user interface, and control the controlled virtual object to sequentially execute the game functions corresponding to the multiple combinable controls in the combination order of the multiple combinable controls corresponding to the composite control in response to a double-click operation on the composite control; and control to change the execution state of the currently executed game function of the controlled virtual object in response to a touch operation on the first target combinable control among the multiple combinable controls corresponding to the composite control in the process of the controlled virtual object sequentially executing the game functions corresponding to the multiple combinable controls in the combination order of the multiple combinable controls corresponding to the composite control.

The above-mentioned function continuous execution module is further configured to display multiple target combinable controls corresponding to the composite control at a specified position of the composite control, and display the execution parameter mark of the game function corresponding to the target combinable control at a specified position of the target combinable control; where the execution parameter mark is configured to indicate the execution time andlor the execution progress of the game function.

The above-mentioned function continuous execution module is further configured to cancel the execution of the game function corresponding to the first target combinable control in the game function execution state in response to a double-click operation on the first target combinable control among the multiple combinable controls corresponding to the composite control.

The above-mentioned function continuous execution module is further configured to control the controlled virtual object to execute the game function corresponding to the first target combinable control in response to a click operation on the first target combinable control among the multiple target combinable controls corresponding to the composite control.

The above-mentioned function continuous execution module is further configured to control the controlled virtual object to stop executing the game function corresponding to the second target combinable control in response to a click operation on the first target combinable control among the multiple target combinable controls corresponding to the composite control in the process of the controlled virtual object executing the game function corresponding to the second target combinable control among the multiple combinable controls; control the controlled virtual object to execute the game function corresponding to the first target combinable control, and continue to execute the game function corresponding to the combinable control located after the first target combinable control in the combination sequence according to the combination sequence of the multiple combinable controls corresponding to the composite control.

The above-mentioned game operation area also displays a cancel control corresponding to the composite control. The above-mentioned device further includes a function stop module, configured to control the controlled virtual object to stop executing the game function corresponding to the current combinable control in response to a click operation on the cancel control, and execute the game function corresponding to the combinable control located after the current combinable control in the combination sequence.

The above-mentioned function continuous execution module is further configured to display multiple target combinable controls corresponding to the composite control at multiple set positions starting from the display position of the composite control in response to the first long press operation on the composite control; determine the target combinable control corresponding to the composite control through which the sliding operation track passes as the target trigger control in response to the sliding operation starting from the target combinable control displayed at the display position of the composite control; and control the controlled virtual object to sequentially execute the game functions corresponding to the target trigger controls in the order in which the sliding operation passes through the target trigger controls in response to the end event of the sliding operation at the display position of the second target combinable control among the multiple target combinable controls corresponding to the composite control.

The above-mentioned device also includes a control display cancel module, configured to display the cancel control corresponding to the composite control at the specified position of the composite control in response to the second long press operation on the composite control; a second cancel module, configured to cancel the display of the composite control in response to the sliding operation starting from the composite control and ending at the cancel control.

The above-mentioned device further includes a second cancel module, configured to cancel the display of the composite control in response to the click operation on the cancel control.

This embodiment also provides an electronic device, including a processor and a memory, the memory storing machine executable instructions that can be executed by the processor, and the processor executing the machine executable instructions to implement the above interactive control method of the game, for example:
in response to a trigger event for control combination, multiple combinable controls in multiple operation controls are displayed in a first display format; in response to a control combination operation, a composite control of multiple target combinable controls corresponding to the control combination operation is displayed; in response to a touch operation acting on the composite control, the controlled virtual object is controlled to continuously execute the game functions of multiple target combinable controls corresponding to the composite control.

The above method meets the diverse game operation requirements of players, makes game operation more convenient, and improves the game experience of players.

In some examples, the above step of displaying multiple combinable controls in multiple operation controls in the first display format in response to the trigger event for control combination includes displaying multiple combinable controls in multiple operation controls in a first display format in response to a touch operation on an operation control in multiple operation controls.

In some examples, the above step of displaying multiple combinable controls in multiple operation controls in the first display format in response to the trigger event for control combination includes displaying at least one combinable control corresponding to the first operation control in the multiple operation controls in the first display format in response to the touch operation on the first operation control in the multiple operation controls.

In some examples, the above step of displaying the composite control of multiple target combinable controls corresponding to the control combination operation in response to the control combination operation includes displaying at least one combinable control corresponding to the first combinable control in the multiple combinable controls in the second display format in response to the first selection operation on the first combinable control in the multiple combinable controls; displaying the composite control corresponding to the first combinable control and at least one second combinable control in response to the second selection operation with the first combinable control and at least one second combinable control in at least one combinable control corresponding to the first combinable control as the selected controls.

In some examples, the second selection operation is a sliding operation, where the track of the sliding operation passes through the first combinable control and at least one second combinable control; or the second selection operation is composed of multiple sub-click operations, where the multiple sub-click operations correspond to the first combinable control and at least one second combinable control.

In some examples, the step of displaying the composite control corresponding to the first combinable control and at least one second combinable control in response to the second selection operation with the first combinable control and at least one second combinable control in at least one combinable control corresponding to the first combinable control as the selected controls includes: displaying the composite control corresponding to the first combinable control and the second combinable control in response to the first sliding operation starting from the position of the first combinable control and ending at a second combinable control in at least one combinable control corresponding to the first combinable control.

In some examples, after displaying the composite control corresponding to the first combinable control and the second combinable control, the method further includes updating the display of the composite control in response to the sliding operation starting from the display position of another second combinable control in at least one combinable control corresponding to the first combinable control and ending at the display position of the composite control. The updated composite control corresponds to the first combinable control and the two second combinable controls.

In some examples, the step of displaying the composite control corresponding to the first and second combinable controls in response to the first sliding operation starting from the position of the first combinable control and ending at a second combinable control in at least one combinable control corresponding to the first combinable control includes controlling the first combinable control to move along with the contact point of the sliding operation in response to the sliding operation starting from the position of the first combinable control; displaying the control combination mark in response to the contact point of the sliding operation moving to the display position of a second combinable control in at least one combinable control corresponding to the first combinable control, where the control combination mark is configured to indicate that the first combinable control is combined with the second combinable control; and displaying the composite control corresponding to the first and second combinable controls at the position of the second combinable control in response to the end event of the sliding operation at the position of the second combinable control.

In some examples, the above step of controlling the controlled virtual object to continuously execute the game functions of the multiple target combinable controls corresponding to the composite control in response to the touch operation on the composite control includes controlling the controlled virtual object to sequentially execute the game functions corresponding to the multiple combinable controls in the combination order of the multiple combinable controls corresponding to the composite control in response to the click operation on the composite control. The combination order of the multiple target combinable controls corresponding to the composite control is determined based on the control combination operation corresponding to the composite control.

In some examples, the above step of controlling the controlled virtual object to continuously execute the game functions of the multiple target combinable controls corresponding to the composite control in response to the touch operation on the composite control includes: in response to the double-click operation on the composite control, displaying the multiple target combinable controls corresponding to the composite control at a specified position of the graphical user interface, and controlling the controlled virtual object to sequentially execute the game functions corresponding to the multiple combinable controls in the combination order of the multiple combinable controls corresponding to the composite control; in the process of the controlled virtual object sequentially executing the game functions corresponding to the multiple combinable controls in the combination order of the multiple combinable controls corresponding to the composite control, controlling to change the execution state of the currently executed game function of the controlled virtual object in response to the touch operation on the first target combinable control among the multiple combinable controls corresponding to the composite control.

In some examples, the step of displaying multiple target combinable controls corresponding to the composite control at the designated position of the graphical user interface includes displaying multiple target combinable controls corresponding to the composite control at the specified position of the composite control, and displaying the execution parameter mark of the game function corresponding to the target combinable control at the specified position of the target combinable control. The execution parameter mark is configured to indicate the execution time and/or the execution progress of the game function.

In some examples, the step of controlling to change the execution state of the currently executed game function of the controlled virtual object in response to the touch operation on the first target combinable control among the multiple combinable controls corresponding to the composite control includes canceling the execution of the game function corresponding to the first target combinable control in the game function execution state in response to the double-click operation on the first target combinable control among the multiple combinable controls corresponding to the composite control.

In some examples, the step of controlling to change the execution state of the currently executed game function of the controlled virtual object in response to the touch operation on the first target combinable control among the multiple combinable controls corresponding to the composite control includes controlling the controlled virtual object to execute the game function corresponding to the first target combinable control in response to the click operation of the first target combinable control among the multiple target combinable controls corresponding to the composite control.

In some examples, the above step of controlling to change the execution state of the currently executed game function of the controlled virtual object in response to a touch operation on a first target combinable control among the multiple combinable controls corresponding to the composite control during the process of the controlled virtual object sequentially executing the game functions corresponding to the multiple combinable controls in accordance with the combination order of the multiple combinable controls corresponding to the composite control includes: in the process of the controlled virtual object executing the game function corresponding to the second target combinable control among the multiple combinable controls, controlling the controlled virtual object to stop executing the game function corresponding to the second target combinable control in response to a click operation on a first target combinable control among the multiple target combinable controls corresponding to the composite control; controlling the controlled virtual object to execute the game function corresponding to the first target combinable control, and continuing to execute the game function corresponding to the combinable control located after the first target combinable control in the combination order according to the combination order of the multiple combinable controls corresponding to the composite control.

In some examples, the game operation area also displays a cancel control corresponding to the composite control. After controlling the controlled virtual object to sequentially execute the game functions corresponding to the multiple combinable controls in the combination order of the multiple combinable controls corresponding to the composite control, the method further includes: in response to a click operation on the cancel control, controlling the controlled virtual object to stop executing the game function corresponding to the current combinable control, and executing the game function corresponding to the combinable control located after the current combinable control in the combination order.

In some examples, the above step of controlling the controlled virtual object to continuously execute the game functions of the multiple target combinable controls corresponding to the composite control in response to the touch operation on the composite control further includes displaying the multiple target combinable controls corresponding to the composite control at multiple set positions starting from the display position of the composite control in response to the first long press operation on the composite control; determining the target combinable controls corresponding to the composite control through which the track of the sliding operation passes as the target trigger controls in response to the sliding operation starting from the target combinable control displayed at the display position of the composite control; and controlling the controlled virtual object to sequentially execute the game functions corresponding to the target trigger controls in the order in which the sliding operation passes through the target trigger controls in response to the end event of the sliding operation at the display position of the second target combinable control in the multiple target combinable controls corresponding to the composite control.

In some examples, after displaying the composite control of the multiple target combinable controls corresponding to the control combination operation, the above method further includes displaying the cancel control corresponding to the composite control at the specified position of the composite control in response to the second long press operation on the composite control; and canceling the display of the composite control in response to the sliding operation starting from the composite control and ending at the cancel control.

In some examples, after displaying the cancel control corresponding to the composite control at the specified position of the composite control, the method further includes canceling the display of the composite control in response to a click operation on the cancel control.

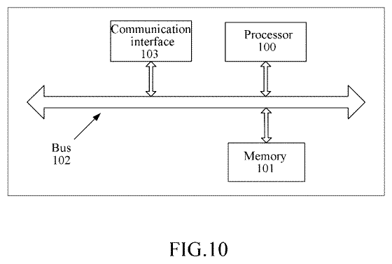

As shown in FIG. 10, the electronic device includes a processor 100 and a memory 101. The memory 101 stores machine executable instructions that can be executed by the processor 100, and the processor 100 executes the machine executable instructions to implement the above interactive control method of the game.

Further, the electronic device shown in FIG. 10 further includes a bus 102 and a communication interface 103. The processor 100, the communication interface 103 and the memory 101 are connected through the bus 102.

The memory 101 may include a high-speed random access memory (RAM), and may further include a non-volatile memory, such as at least one disk storage. The communication connection between the system network element and at least one other network element is realized through at least one communication interface 103 (which may be wired or wireless), and the Internet, wide area network, local area network, metropolitan area network, etc. can be used. The bus 102 can be an ISA bus, a PCI bus, or an EISA bus, etc. The bus can be classified into an address bus, a data bus, a control bus, etc. For ease of representation, the bus in FIG. 10 is represented by only one bidirectional arrow, but it does not mean that there is only one bus or one type of bus.

The processor 100 may be an integrated circuit chip with signal processing capabilities. In the implementation process, each step of the above method can be completed by an integrated logic circuit of hardware in the processor 100 or instructions in the form of software. The above processor 100 may be a general-purpose processor, including a central processing unit (CPU), a network processor (NP), etc.; it may also be a digital signal processor (DSP), an application specific integrated circuit (ASIC), a field programmable gate array (FPGA), or other programmable logic devices, discrete gates or transistor logic devices, discrete hardware components. The methods, steps, and logic block diagrams in the embodiments of the present disclosure may be implemented or executed. The general-purpose processor may be a microprocessor or the processor may also be any conventional processor, etc. The steps of the method disclosed in the embodiment of the present disclosure can be directly embodied as being executed by a hardware decoding processor, or being executed by a combination of hardware and software modules in the decoding processor. The software module can be located in a mature storage medium in the field such as a random access memory, a flash memory, a read-only memory, a programmable read-only memory, or an electrically erasable programmable memory, a register, etc. The storage medium is located in the memory 101, and the processor 100 reads the information in the memory 101 and completes the steps of the method of the aforementioned embodiment in combination with its hardware.

This embodiment also provides a machine-readable storage medium, which stores machine-executable instructions. When the machine-executable instructions are called and executed by the processor, the machine-executable instructions cause the processor to implement the above interactive control method of the game.

The interactive control method, device for a game and the electronic device provided by the embodiments of the present disclosure include a computer-readable storage medium storing a program code, and the instructions included in the program code can be configured to execute the method described in the previous method embodiment, for example:
in response to a trigger event for control combination, displaying multiple combinable controls in multiple operation controls in a first display format; in response to a control combination operation, displaying a composite control of multiple target combinable controls corresponding to the control combination operation; in response to a touch operation on the composite control, controlling the controlled virtual object to continuously execute the game functions of multiple target combinable controls corresponding to the composite control.

The above method meets the diverse game operation requirements of players, makes game operation more convenient, and improves the game experience of players.

In some examples, the above step of displaying multiple combinable controls in multiple operation controls in the first display format in response to the trigger event for control combination includes displaying multiple combinable controls in multiple operation controls in the first display format in response to a touch operation on an operation control in multiple operation controls.

In some examples, the step of displaying multiple combinable controls in the multiple operation controls in the first display format in response to the trigger event for control combination includes displaying at least one combinable control corresponding to the first operation control in the multiple operation controls in the first display format in response to the touch operation on the first operation control in the multiple operation controls.

In some examples, the step of displaying the composite control of multiple target combinable controls corresponding to the control combination operation in response to the control combination operation includes displaying at least one combinable control corresponding to the first combinable control in the multiple combinable controls in the second display format in response to the first selection operation on the first combinable control in the multiple combinable controls; displaying the composite control corresponding to the first combinable control and at least one second combinable control in response to the second selection operation with the first combinable control and at least one second combinable control in at least one combinable control corresponding to the first combinable control as the selected controls.

In some examples, the second selection operation is a sliding operation, where the track of the sliding operation passes through the first combinable control and at least one second combinable control; or the second selection operation is composed of multiple sub-click operations, where the multiple sub-click operations correspond to the first combinable control and at least one second combinable control.

In some examples, the step of displaying the composite control corresponding to the first combinable control and at least one second combinable control in response to the second selection operation with the first combinable control and at least one second combinable control in at least one combinable control corresponding to the first combinable control as the selected controls includes displaying the composite control corresponding to the first combinable control and the second combinable control in response to the first sliding operation starting from the position of the first combinable control and ending at a second combinable control in at least one combinable control corresponding to the first combinable control.

In some examples, after displaying the composite control corresponding to the first combinable control and the second combinable control, the method further includes updating the display of the composite control in response to the sliding operation starting from the display position of another second combinable control in at least one combinable control corresponding to the first combinable control and ending at the display position of the composite control; the updated composite control corresponds to the first combinable control and the two second combinable controls.

In some examples, the step of displaying the composite control corresponding to the first and second combinable controls in response to the first sliding operation starting from the position of the first combinable control and ending at a second combinable control in at least one combinable control corresponding to the first combinable control includes controlling the first combinable control to move along with the contact point of the sliding operation in response to the sliding operation starting from the position of the first combinable control; displaying the control combination mark in response to the contact point of the sliding operation moving to the display position of a second combinable control in at least one combinable control corresponding to the first combinable control, where the control combination mark is configured to indicate that the first combinable control is combined with the second combinable control; and displaying the composite control corresponding to the first and second combinable controls at the position of the second combinable control in response to the end event of the sliding operation at the position of the second combinable control.

In some examples, the above-mentioned step of controlling the controlled virtual object to continuously execute the game functions of multiple target combinable controls corresponding to the composite control in response to the touch operation on the composite control includes: controlling the controlled virtual object to sequentially execute the game functions corresponding to the multiple combinable controls according to the combination order of the multiple combinable controls corresponding to the composite control in response to the click operation on the composite control. The combination order of the multiple target combinable controls corresponding to the composite control is determined based on the control combination operation corresponding to the composite control.

In some examples, the above step of controlling the controlled virtual object to continuously execute the game functions of the multiple target combinable controls corresponding to the composite control in response to the touch operation on the composite control includes, in response to the double-click operation on the composite control, displaying the multiple target combinable controls corresponding to the composite control at the specified position of the graphical user interface, and controlling the controlled virtual object to sequentially execute the game functions corresponding to the multiple combinable controls in the combination order of the multiple combinable controls corresponding to the composite control; in the process of the controlled virtual object sequentially executing the game functions corresponding to the multiple combinable controls in the combination order of the multiple combinable controls corresponding to the composite control, controlling to change the execution state of the currently executed game function of the controlled virtual object in response to the touch operation on the first target combinable control among the multiple combinable controls corresponding to the composite control.

In some examples, the above step of displaying the multiple target combinable controls corresponding to the composite control at the specified position of the graphical user interface includes displaying the multiple target combinable controls corresponding to the composite control at the specified position of the composite control, and displaying the execution parameter mark of the game function corresponding to the target combinable control at the specified position of the target combinable control. The execution parameter mark is configured to indicate the execution time and or the execution progress of the game function.

In some examples, the step of controlling to change the execution state of the currently executed game function of the controlled virtual object in response to the touch operation on the first target combinable control among the multiple combinable controls corresponding to the composite control includes canceling the execution of the game function corresponding to the first target combinable control in the game function execution state in response to the double-click operation on the first target combinable control among the multiple combinable controls corresponding to the composite control.

In some examples, the step of controlling to change the execution state of the currently executed game function of the controlled virtual object in response to the touch operation on the first target combinable control among the multiple combinable controls corresponding to the composite control includes controlling the controlled virtual object to execute the game function corresponding to the first target combinable control in response to the click operation on the first target combinable control among the multiple target combinable controls corresponding to the composite control.

In some examples, the above step of controlling to change the execution state of the currently executed game function of the controlled virtual object in response to the touch operation on the first target combinable control among the multiple combinable controls corresponding to the composite control during the process of the controlled virtual object sequentially executing the game functions corresponding to the multiple combinable controls in accordance with the combination order of the multiple combinable controls corresponding to the composite control includes, in the process of the controlled virtual object executing the game function corresponding to the second target combinable control among the multiple combinable controls, controlling the controlled virtual object to stop executing the game function corresponding to the second target combinable control in response to a click operation on a first target combinable control among the multiple target combinable controls corresponding to the composite control; controlling the controlled virtual object to execute the game function corresponding to the first target combinable control, and continuing to execute the game function corresponding to the combinable control located after the first target combinable control in the combination order according to the combination order of the multiple combinable controls corresponding to the composite control.

In some examples, the game operation area also displays a cancel control corresponding to the composite control. After controlling the controlled virtual object to sequentially execute the game functions corresponding to the multiple combinable controls in the combination order of the multiple combinable controls corresponding to the composite control, the method further includes, in response to a click operation on the cancel control, controlling the controlled virtual object to stop executing the game function corresponding to the current combinable control, and executing the game function corresponding to the combinable control located after the current combinable control in the combination order.

In some examples, the above step of controlling the controlled virtual object to continuously execute the game functions of the multiple target combinable controls corresponding to the composite control in response to the touch operation on the composite control further includes: displaying the multiple target combinable controls corresponding to the composite control at multiple set positions starting from the display position of the composite control in response to the first long press operation on the composite control; determining the target combinable controls corresponding to the composite control through which the track of the sliding operation passes as the target trigger controls in response to the sliding operation starting from the target combinable control displayed at the display position of the composite control; controlling the controlled virtual object to sequentially execute the game functions corresponding to the target trigger controls in the order in which the sliding operation passes through the target trigger controls in response to the end event of the sliding operation ending at the display position of the second target combinable control in the multiple target combinable controls corresponding to the composite control.

In some examples, after displaying the composite control of the multiple target combinable controls corresponding to the control combination operation, the above method further includes displaying the cancel control corresponding to the composite control at the specified position of the composite control in response to the second long press operation on the composite control; and canceling the display of the composite control in response to the sliding operation starting from the composite control and ending at the cancel control.

In some examples, after displaying the cancel control corresponding to the composite control at the specified position of the composite control, the method further includes canceling the display of the composite control in response to a click operation on the cancel control.

Those skilled in the art can clearly understand that for the convenience and simplicity of description, the specific working process of the system and device described above can refer to the corresponding process in the aforementioned method embodiment, and will not be repeated here.

In addition, in the description of the embodiments of the present disclosure, unless otherwise clearly specified and limited, the terms “installation”, “connection”, and “link” should be understood in a broad sense. For example, it can be a fixed connection, a detachable connection, or an integral connection. It can be a mechanical connection or an electrical connection. It can be directly connected, or indirectly connected through an intermediate medium, or it can be the internal connection of two components. For those skilled in the art, the specific meanings of the above terms in the present disclosure can be understood according to the specific situation.

If the functions are implemented in the form of software functional units and sold or used as independent products, they can be stored in a computer-readable storage medium. Based on such understanding, the technical solution of the present disclosure, in essence, or the part that contributes to the prior art, or the part of the technical solution, can be embodied in the form of a software product, and the computer software product is stored in a storage medium, including several instructions for enabling a computer device (which may be a personal computer, a server, or a network device, etc.) to perform all or part of the steps of the method described in each embodiment of the present disclosure. The aforementioned storage medium includes: U disk, mobile hard disk, read-only memory (ROM), random access memory (RAM), disk or optical disk, etc., which can store program code.

In the description of the present disclosure, it should be noted that the terms “center”, “up”, “down”, “left”, “right”, “vertical”, “horizontal”, “inside”, “outside” and the like indicate the orientation or position relationship based on the orientation or position relationship shown in the accompanying drawings, which is only for the convenience of describing the present disclosure and simplifying the description, and does not indicate or imply that the device or element referred to must have a specific orientation, be constructed and operated in a specific orientation, and therefore cannot be understood as a limitation on the present disclosure. In addition, the terms “first”, “second” and “third” are only used for descriptive purposes and cannot be understood as indicating or implying relative importance.

Finally, it should be noted that the above embodiments are only specific implementation methods of the present disclosure, which are used to illustrate the technical solutions of the present disclosure, rather than to limit them. The protection scope of the present disclosure is not limited thereto. Although the present disclosure is described in detail with reference to the above embodiments, those skilled in the art should understand that any person skilled in the art who is familiar with the technical field can still modify the technical solutions recorded in the above embodiments within the technical scope disclosed in the present disclosure, or can easily think of changes, or make equivalent replacements for some of the technical features therein; and these modifications, changes or replacements do not make the essence of the corresponding technical solutions deviate from the spirit and scope of the technical solutions of the embodiments of the present disclosure, and should be covered within the protection scope of the present disclosure. Therefore, the protection scope of the present disclosure shall be subject to the protection scope of the claims.

1. An interactive control method for a game, comprising:
providing a graphical user interface through a terminal device, wherein the graphical user interface displays a scene screen of a game scene where a controlled virtual object is located and a game operation area, the game operation area displays multiple operation controls, and the operation controls are configured to control the controlled virtual object to perform corresponding game functions;
displaying multiple combinable controls among multiple operation controls in a first display format in response to a trigger event of control combination;
displaying a composite control of multiple target combinable controls corresponding to a control combination operation in response to the control combination operation; and
controlling the controlled virtual object to continuously perform game functions of the multiple target combinable controls corresponding to the composite control in response to a touch operation on the composite control.

2. The method according to claim 1, wherein displaying the multiple combinable controls among the multiple operation controls in the first display format in response to the trigger event for control combination comprises:
displaying the multiple combinable controls among the multiple operation controls in the first display format in response to a touch operation on an operation control among the multiple operation controls.

3. The method according to claim 1, wherein displaying the multiple combinable controls among the multiple operation controls in the first display format in response to the trigger event for control combination comprises:
displaying at least one combinable control corresponding to a first operation control among the multiple operation controls in the first display format in response to a touch operation on the first operation control among the multiple operation controls.

4. The method according to claim 1, wherein displaying the composite control of the multiple target combinable controls corresponding to the control combination operation in response to the control combination operation comprises:
displaying at least one combinable control corresponding to a first combinable control in the multiple combinable controls in a second display format in response to a first selection operation on the first combinable control among the multiple combinable controls; and
displaying the composite control corresponding to the first combinable control and at least one second combinable control in response to a second selection operation with the first combinable control and the at least one second combinable control among the at least one combinable control corresponding to the first combinable control as selected controls.

5. The method according to claim 4, wherein the second selection operation is a sliding operation, wherein a track of the sliding operation passes through the first combinable control and the at least one second combinable control; or the second selection operation is composed of multiple sub-click operations, wherein the multiple sub-click operations correspond to the first combinable control and the at least one second combinable control.

6. The method according to claim 4, wherein displaying the composite control corresponding to the first combinable control and the at least one second combinable control in response to the second selection operation with the first combinable control and the at least one second combinable control among the at least one combinable control corresponding to the first combinable control as the selected controls comprises:
displaying the composite control corresponding to the first combinable control and the second combinable control in response to a first sliding operation starting from a position of the first combinable control and ending at a second combinable control among the at least one combinable control corresponding to the first combinable control.

7. The method according to claim 6, further comprising:
updating display of the composite control in response to a sliding operation starting from a display position of another second combinable control among the at least one combinable control corresponding to the first combinable control and ending at a display position of the composite control; the updated composite control corresponds to the first combinable control and the two second combinable controls.

8. The method according to claim 6, wherein displaying the composite control corresponding to the first combinable control and the second combinable control in response to the first sliding operation starting from the position of the first combinable control and ending at the second combinable control among the at least one combinable control corresponding to the first combinable control comprises:
controlling the first combinable control to move along with a contact point of the sliding operation in response to the sliding operation starting from the position of the first combinable control;
displaying a control combination mark in response to the contact point of the sliding operation moving to a display position of the second combinable control among the at least one combinable control corresponding to the first combinable control; the control combination mark is configured to indicate that the first combinable control is combined with the second combinable control; and
displaying the composite control corresponding to the first combinable control and the second combinable control at the position of the second combinable control in response to an end event of the sliding operation at the position of the second combinable control.

9. The method according to claim 1, wherein controlling the controlled virtual object to continuously execute the game functions of the multiple target combinable controls corresponding to the composite control in response to the touch operation on the composite control comprises:
controlling the controlled virtual object to sequentially execute the game functions corresponding to the multiple combinable controls in accordance with a combination order of the multiple combinable controls corresponding to the composite control in response to a click operation on the composite control; the combination order of the multiple target combinable controls corresponding to the composite control is determined based on the control combination operation corresponding to the composite control.

10. The method according to claim 1, wherein controlling the controlled virtual object to continuously execute the game functions of the multiple target combinable controls corresponding to the composite control in response to the touch operation on the composite control comprises:
in response to a double-click operation on the composite control, displaying the multiple target combinable controls corresponding to the composite control at a specified position of the graphical user interface, and controlling the controlled virtual object to sequentially execute the game functions corresponding to the multiple combinable controls in accordance with a combination order of the multiple combinable controls corresponding to the composite control; and
in a process of the controlled virtual object sequentially executing the game functions corresponding to the multiple combinable controls in accordance with the combination order of the multiple combinable controls corresponding to the composite control, controlling to change an execution state of a currently executed game function of the controlled virtual object in response to a touch operation on a first target combinable control among the multiple combinable controls corresponding to the composite control.

11. The method according to claim 10, wherein displaying the multiple target combinable controls corresponding to the composite control at the specified position of the graphical user interface comprises:
displaying the multiple target combinable controls corresponding to the composite control at the specified position of the composite control, and displaying execution parameter marks of the game functions corresponding to the target combinable controls at specified positions of the target combinable controls; wherein the execution parameter marks are configured to indicate at least one of execution time or execution progresses of the game functions.

12. The method according to claim 10, wherein controlling to change the execution state of the currently executed game function of the controlled virtual object in response to the touch operation on the first target combinable control among the multiple combinable controls corresponding to the composite control comprises:
canceling execution of a game function corresponding to the first target combinable control in the execution state of the game functions in response to a double-click operation on the first target combinable control among the multiple combinable controls corresponding to the composite control.

13. The method according to claim 10, wherein controlling to change the execution state of the currently executed game function of the controlled virtual object in response to the touch operation on the first target combinable control among the multiple combinable controls corresponding to the composite control comprises:
controlling the controlled virtual object to execute a game function corresponding to the first target combinable control in response to a click operation on the first target combinable control among the multiple target combinable controls corresponding to the composite control.

14. The method according to claim 10, wherein in the process of the controlled virtual object sequentially executing the game functions corresponding to the multiple combinable controls according to the combination order of the multiple combinable controls corresponding to the composite control, controlling to change the execution state of the currently executed game function of the controlled virtual object in response to the touch operation on the first target combinable control among the multiple combinable controls corresponding to the composite control comprises:
in a process of the controlled virtual object executing a game function corresponding to a second target combinable control among the multiple combinable controls, controlling the controlled virtual object to stop executing the game function corresponding to the second target combinable control in response to a click operation on the first target combinable control among the multiple target combinable controls corresponding to the composite control; and
controlling the controlled virtual object to execute a game function corresponding to the first target combinable control, and continuing to execute a game function corresponding to a combinable control located after the first target combinable control in the combination order according to the combination order of the multiple combinable controls corresponding to the composite control.

15. The method according to claim 10, wherein the game operation area further displays a cancel control corresponding to the composite control; and
the method further comprises:
in response to a click operation on the cancel control, controlling the controlled virtual object to stop executing a game function corresponding to a current combinable control and execute a game function corresponding to a combinable control located after the current combinable control in the combination order.

16. The method according to claim 1, wherein controlling the controlled virtual object to continuously execute the game functions of the multiple target combinable controls corresponding to the composite control in response to the touch operation on the composite control further comprises:
displaying the multiple target combinable controls corresponding to the composite control at multiple set positions starting from a display position of the composite control in response to a first long press operation on the composite control;
determining target combinable controls corresponding to the composite control through which a track of the sliding operation passes as target trigger controls in response to a sliding operation starting from a target combinable control displayed at the display position of the composite control; and
controlling the controlled virtual object to sequentially execute game functions corresponding to the target trigger controls in an order in which the sliding operation passes through the target trigger controls in response to an end event of the sliding operation at a display position of a second target combinable control among the multiple target combinable controls corresponding to the composite control.

17. The method according to claim 1, further comprising:
displaying a cancel control corresponding to the composite control at a specified position of the composite control in response to a second long press operation on the composite control; and
canceling display of the composite control in response to a sliding operation starting from the composite control and ending at the cancel control.

18. The method according to claim 17, further comprising:
canceling the display of the composite control in response to a click operation on the cancel control.

19. (canceled)

20. An electronic device, comprising a processor and a memory, wherein the memory stores machine executable instructions that can be executed by the processor, and the processor executes the machine executable instructions to:
provide a graphical user interface, wherein the graphical user interface displays a scene screen of a game scene where a controlled virtual object is located and a game operation area, the game operation area displays multiple operation controls, and the operation controls are configured to control the controlled virtual object to perform corresponding game functions;
display multiple combinable controls among multiple operation controls in a first display format in response to a trigger event of control combination;
display a composite control of multiple target combinable controls corresponding to a control combination operation in response to the control combination operation; and
control the controlled virtual object to continuously perform game functions of the multiple target combinable controls corresponding to the composite control in response to a touch operation on the composite control.

21. A non-transitory machine-readable storage medium, wherein the non-transitory machine-readable storage medium stores machine-executable instructions, and when the machine-executable instructions are called and executed by a processor, the machine-executable instructions cause the processor to:
provide a graphical user interface, wherein the graphical user interface displays a scene screen of a game scene where a controlled virtual object is located and a game operation area, the game operation area displays multiple operation controls, and the operation controls are configured to control the controlled virtual object to perform corresponding game functions;
display multiple combinable controls among multiple operation controls in a first display format in response to a trigger event of control combination;
display a composite control of multiple target combinable controls corresponding to a control combination operation in response to the control combination operation; and
control the controlled virtual object to continuously perform game functions of the multiple target combinable controls corresponding to the composite control in response to a touch operation on the composite control.
